(19) United States
(12) Patent Application Publication
(10) Pub. No.: US 2002/0093814 A1
(43) Pub. Date: Jul. 18, 2002

(54) Illuminated note board

(76) Inventor: Wendelin Egli, (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/758,159

(22) Filed: Jan. 12, 2001

(30) Foreign Application Priority Data
Jan. 12, 2000 (EP) 00810027.3

(51) Int. Cl. F21V 33/00

(52) U.S. Cl. 362/99; 362/84

(57) ABSTRACT

The note board has a writing surface and a writing instrument accommodated in a holder. The writing surface is situated on a transparent recording substrate, under which a light source, serving as background illumination, is disposed. A solar panel and an accumulator supply the light source with electrical power. A reed switch is actuated by means of a permanent magnet disposed on the writing instrument in such a way that the light source is switched on as soon as the writing instrument is taken from the holder. The note board is completely watertight, so that it can be used underwater by divers.

This invention relates to a note board with a recording substrate having a writing surface, a writing instrument, a light source for illumination of the writing surface, as well as a power source and a switch for the light source.

Note boards of this kind are known. For example, U.S. Pat. No. 3,697,737 (Levkoff) shows a note board with a tray-like receptacle for the recording substrate, which, in this case, can consist of sheets of paper. On its upper edge, the receptacle has a roughly oblong thicker part which extends over the width of the board and protrudes over the plane of the writing surface. Provided in the thicker part is a light source in the form of an incandescent bulb and a battery. An aperture provided in the thicker part serves for insertion of a pen when the pen is not being used. Provided in the aperture is a switch that switches off the bulb when the pen is inserted.

The drawbacks of this known note board are, in particular, that the light source disposed on their upper edge is not able to illuminate the writing surface evenly, and shadows are cast. It is also not suitable for use in a damp or wet environment.

Also known, moreover, are flat light sources, for example in the form of so-called electroluminescent lights or EL lamps. Lights sources of this kind are used inter alia for background illumination of screens, for example for portable personal computers and similar devices, for example laptops, electronic notebooks, palmtops and hand-held computers. There is even a method, known under the U.S. Pat. No. 5,856,031, by means of which electroluminescent layers can be applied to almost any supporting surface by means of serigraphy.

With this state of the art as a point of departure, the invention has as its object to propose a note board of the aforementioned type in which the writing surface is illuminated evenly and without casting shadows.

This object is achieved according to the invention in that the writing surface is transparent and the light source is designed as background lighting.

The transparent writing substrate and the background lighting make for an even and shadow-free illumination of the writing surface, and make it possible to work with the note board according to the invention even in bad weather conditions.

If, according to an especially preferred embodiment of the invention, the light source is an electroluminescent lamp, low-energy operation is achieved, and unnecessary generation of heat by the light source is avoided.

According to a further preferred embodiment, the energy source comprises at least one photoelectric element and at least one accumulator. Such a note board can be placed in a bright place when not in use, and can thus store energy for the next time it is used.

If the switch for turning the light source on and off is designed as a reed switch, this switch can be actuated from outside by means of a permanent magnet. This facilitates creating a hermetically sealed embodiment of the note board according to the invention. Especially preferred is that the writing instrument bears a permanent magnet with which the reed switch can be actuated.

If a holder for the writing instrument is disposed on the note board in such a way that the reed switch can be actuated through the permanent magnet of the writing instrument when the writing instrument is accommodated in the holder, the light source can be switch-controlled in such a way that it switches on automatically as soon as the writing instrument is taken from the holder.

Finally, if, according to an especially preferred embodiment of the invention, a watertight sheathing is provided, which encloses at least the light source, the power source and the areas of the writing substrate adjoining the writing surface, a note board is obtained which is suitable as a means of communication for divers.

Special example embodiments of the invention will be explained more closely in the following, with reference to the drawings:

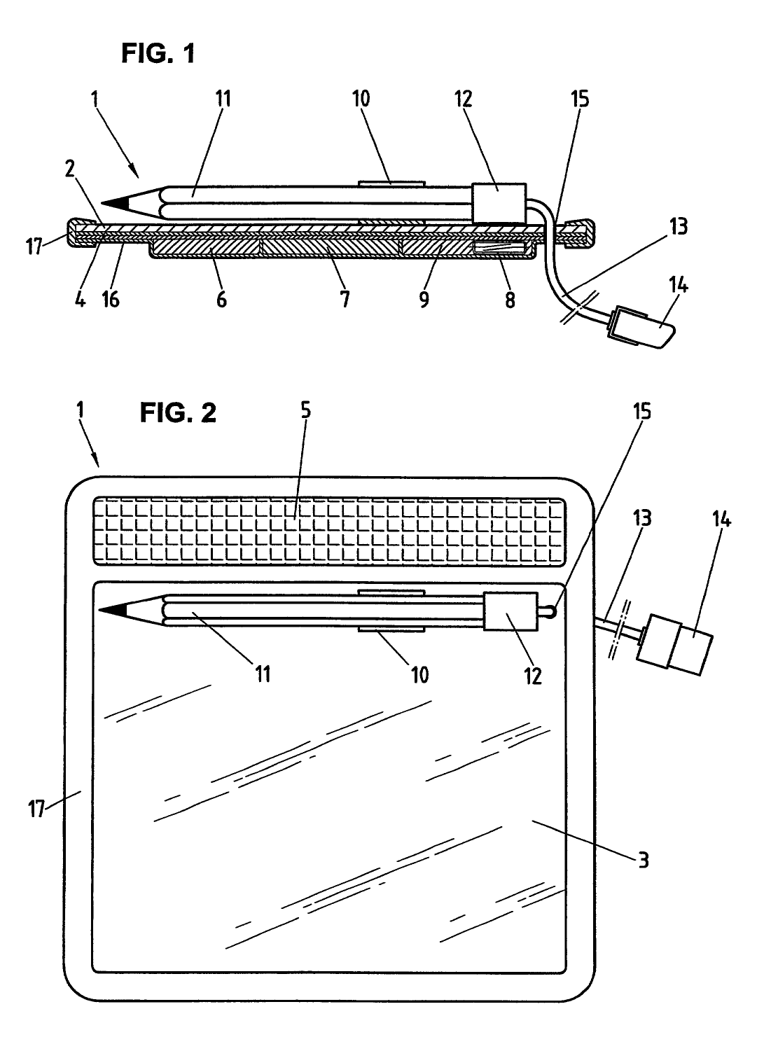

FIG. 1 is a cross-section through a note board suitable for divers;

FIG. 2 is a view from above of the note board according to FIG. 1; and

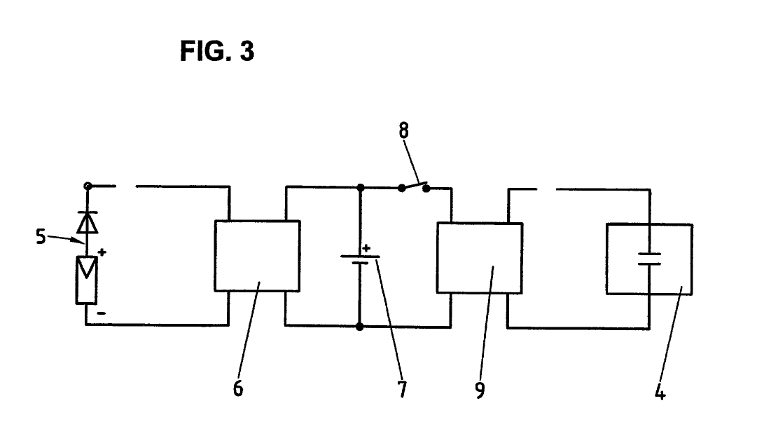

FIG. 3 is a block diagram of the electrical components of the note board according to FIGS. 1 and 2.

The note board designated by 1 in FIGS. 1 and 2 is conceived for use by divers, and is therefore designed completely watertight. The electrical components can be seen in particular in the block diagram according to FIG. 3.

The recording substrate 2 preferably consists of a foil or a panel of transparent plastic, the surface of which serves as the writing surface 3, and can be slightly roughened for this purpose. It has been shown that a slightly roughened surface can be written upon even underwater using a simple pencil, it being possible to remove the characters simply using an eraser. As a variant, use of replaceable foil sheets or sheets of paper is of course also conceivable.

An electroluminescent foil 4, in the following referred to as EL-foil, is disposed behind the recording substrate 2 as the light source. Of course any other light source could also be used as background illumination for the writing surface. However, an EL-foil is especially preferred for the purpose described here. A solar panel 5, which is disposed on the edge of the writing surface 2, serves to feed the EL-foil with electrical energy. It would of course also be possible to use a semi-transparent solar panel which covers the entire surface of the writing panel. Although such solar cells operate less efficiently than the conventional ones, this is compensated for through the enlarged active area. A note board thus equipped would have the advantage over that shown in FIG. 2 that practically its entire surface could be used for notes or sketches. The energy delivered by the solar panel 5 is supplied, via a charging controller 6, to an accumulator 7, which stores the energy. Provided to switch the light source 4 on and off is a switch 8, which is preferably designed as a reed switch. Finally, an EL-driver 9 is provided, which generates the necessary voltage and frequency to cause the EL-foil to light up. A holder 10 for a writing instrument 11 is mounted on the recording substrate 2 in the vicinity of the solar panel 5. The writing instrument 11, which in this example is a pencil, bears a permanent magnet 12 on its rear end, which magnet actuates the reed switch 8 when the writing instrument 11 is received in the holder 10, as shown.

An eraser 14 is connected to the end of the writing instrument 11 via a cord 13 or the like, shown shortened in FIGS. 1 and 2. The cord 13 is led through an aperture 15 in the note board 1, so that both the writing instrument 11 and the eraser are connected to the notice board 1 in a such way that they cannot be lost. A frame 17 surrounds both the recording substrate 2 and the solar panel 5, and is sealed in a watertight way to a back cover 16.

The note board can of course be designed without solar panel 5. The charging controller 6 can nevertheless be provided in this case, it being possible for its inputs to be connected to plug contacts for an external power source, for example. Using an external charging controller is of course also conceivable. If, according to a further embodiment, a simple battery is provided instead of the accumulator 7, the charging controller 6 can of course be omitted. In this case, the watertight sheathing should be able to be opened for exchange of the battery. Battery compartments with watertight lids are known, and therefore are not further described here.

What is claimed is:

1. A note board with a recording substrate having a writing surface, a writing instrument, a light source for illumination of the writing surface as well as a power source and a switch for the light source, wherein the recording substrate is transparent and the light source is designed as background illumination.

2. The note board of claim 1, wherein the light source is an electroluminescent light, preferably in the form of a foil.

3. The note board of claim 1, wherein the power source comprises at least one photoelectric element and at least one accumulator.

4. The note board of claim 2, wherein the power source comprises at least one photoelectric element and at least one accumulator.

5. The note board of claim 1, wherein the switch is a reed switch.

6. The note board of claim 2, wherein the switch is a reed switch.

7. The note board of claim 3, wherein the switch is a reed switch.

8. The note board of claim 4, wherein the switch is a reed switch.

9. The note board of claim 5, wherein the writing instrument bears a permanent magnet which functions as an actuator for the reed switch.

10. The note board of claim 9, further comprising a holder for the writing instrument which holder is disposed on the note board in such a way that the reed switch is actuated by means of the magnet of the writing instrument accommodated in the holder, and the light source is thereby switched off.

11. The note board of one of the preceding claims, further comprising a watertight sheathing which encloses at least the light source, the power source and the areas of the recording substrate adjoining the writing surface.
